(19) United States
(12) Patent Application Publication
(10) Pub. No.: US 2025/0349527 A1
(43) Pub. Date: Nov. 13, 2025

(54) Mass Spectrometry Data Processing Method and Mass Spectrometer

(71) Applicant: SHIMADZU CORPORATION, Kyoto-shi (JP)

(72) Inventors: Hiroko UEDA, Kyoto-shi (JP); Masaru NISHIGUCHI, Kyoto-shi (JP)

(21) Appl. No.: 19/199,009

(22) Filed: May 5, 2025

(30) Foreign Application Priority Data
May 9, 2024 (JP) 2024-076650

(51) Int. Cl. H01J 49/00

(52) U.S. Cl. CPC H01J 49/0036

(57) ABSTRACT

A peak-information acquirer detects peaks in a m/z spectrum based on mass spectrometry data acquired by a measurement section and collects peak information including m/z values of the peaks. An approximate-mass calculator calculates approximate masses by multiplying the m/z value of each peak by each of the numbers of charges within an expected charge-number range determined beforehand. A class selector determines, for a plurality of approximate masses, the frequency of each approximate mass or each class having a predetermined mass width as a likelihood of the approximate mass and selects an approximate mass or a class estimated to be highly reliable based on the likelihood. An estimated-mass calculator calculates an estimated mass of a compound corresponding to an approximate mass included in one or more approximate masses or classes selected, based on the peak information and the number of charges of the corresponding peak used for calculating that approximate mass.

### TECHNICAL FIELD

The present invention relates to a data processing method for processing data collected with a mass spectrometer as well as a mass spectrometer employing the same data processing method.

### BACKGROUND ART

When a high molecular compound, such as an antibody protein, is analyzed with a mass spectrometer employing an electrospray ionization (ESI) or similar ionization method, multiply charged ions having a considerably wide range of numbers of charges are detected. Multiply charged ions originating from adducts which result from the addition of various substances to the targeted high molecular compound are also often detected. Furthermore, when a mass spectrometric analysis on such a high molecular compound is performed with a mass spectrometer having a high level of mass-resolving power, it is often the case that one ion peak having a certain number of charges is detected as a plurality of separate ion peaks according to the isotopic ratio, with the result that an isotopic envelope emerges in the mass spectrum. Due to these causes, the spectrum pattern of a mass spectrum acquired by a mass spectrometric analysis has a significantly complex shape even when only a single kind of compound is contained in the sample to be analyzed. Therefore, it will be a difficult task when the user attempts to visually locate, in such a mass spectrum, a peak which originates from the target compound and has a known number of charges or known isotopic ratio and to estimate the mass from the mass-to-charge ratio (m/z) value of the located peak.

To address this problem, in an analysis of this type of mass spectrometry data, a data processing method called the “charge deconvolution” has generally been performed in which various peaks originating from each molecule selected from a mass spectrum is assigned to the mass of that molecule (see Non Patent Literature 1). Various algorithms have been known for the charge deconvolution. The algorithm disclosed in Non Patent Literature 2 uses a model function, while the one disclosed in Non Patent Literature 3 utilizes Basian estimation.

### CITATION LIST

### Non Patent Literature

Non Patent Literature 1: Iain D. G. Campuzano and 10 other authors, “Native and Denaturing MS Protein Deconvolution for Biopharma: Monoclonal Antibodies and Antibody-Drug-Conjugates to Polydisperse Membrane Proteins and Beyond”, Analytical Chemistry, 2019, Vol. 91, No. 15, pp.9472-9480, the Internet
Non Patent Literature 2: Marshall Bern and 11 other authors, “Parsimonious Charge Deconvolution for Native Mass Spectrometry”, Journal of Proteome Research, 2018, Vol. 17, No. 3, pp.1216-1226, the Internet
Non Patent Literature 3: Michael T. Marty, and five other authors, “Bayesian Deconvolution of Mass and Ion Mobility Spectra: From Binary Interactions to Polydisperse Ensembles”, Analytical Chemistry, 2015, Vol. 87, pp.4370-4376, the Internet
Non Patent Literature 4: “UniDec: Universal Deconvolution of Mass and Ion Mobility Spectra”, MARTY LAB, [online], [accessed on May 9, 2024], the Internet

### SUMMARY OF INVENTION

### Technical Problem

Some of the charge deconvolution methods using the various aforementioned computation techniques perform not only the calculation of an average mass of the detected molecules or adducts but also the estimation of a monoisotopic mass which does not appear in the mass spectrum due to its low abundance ratio and extremely low signal, as well as the estimation of an isotopic envelope reflecting the mass-resolving power. However, these conventional techniques for charge deconvolution have the problem that an artefact which actually does not exist (e.g., a false signal which apparently has a peak shape) may possibly be included in the processing result. Furthermore, since their computation processing is generally complex, there is also the problem that a high-capacity memory is required for the processing as well as the problem that the period of time required for the result to converge is unpredictable. Still another problem is that the optimization of the parameter conditions for obtaining a result desired by the user may be difficult depending on the charge deconvolution algorithm used.

The present invention has been developed to solve these problems. One of its primary objectives is to provide a mass spectrometry data processing method and a mass spectrometer capable of obtaining a highly reliable processing result by avoiding the occurrence of artefacts in charge deconvolution.

### Solution to Problem

One mode of the mass spectrometry data processing method according to the present invention is a data processing method for processing data acquired by performing a mass spectrometric analysis on a sample, including:
a peak-information acquisition step for performing peak detection on a m/z spectrum based on the acquired data, and for collecting peak information including the m/z values of a plurality of detected peaks;
an approximate-mass calculation step for calculating approximate masses by multiplying the m/z value of each peak included in the peak information, by each of a plurality of numbers of charges within an expected charge-number range determined beforehand;
a class selection step for determining, for a plurality of approximate masses calculated in the approximate-mass calculation step, the frequency of each approximate mass or each class having a predetermined mass width as a likelihood of the approximate mass, and for selecting an approximate mass or a class estimated to be highly reliable based on the likelihood; and
an estimated-mass calculation step for calculating an estimated mass of a compound corresponding to an approximate mass included in one or more approximate masses or classes selected in the class selection step, based on the peak information and the number of charges of the corresponding peak used for calculating that approximate mass in the approximate-mass calculation step.

One mode of the mass spectrometer according to the present invention includes:
a measurement section configured to perform a mass spectrometric analysis on a sample to acquire data;
a peak-information acquirer configured to perform peak detection on a m/z spectrum based on the data acquired by the measurement section, and to collect peak information including the m/z values of a plurality of detected peaks;
an approximate-mass calculator configured to calculate approximate masses by multiplying the m/z value of each peak included in the peak information, by each of a plurality of numbers of charges within an expected charge-number range determined beforehand;
a class selector configured to determine, for a plurality of approximate masses calculated by the approximate-mass calculator, the frequency of each approximate mass or each class having a predetermined mass width as a likelihood of the approximate mass and to select an approximate mass or a class estimated to be highly reliable based on the likelihood; and
an estimated-mass calculator configured to calculate an estimated mass of a compound corresponding to an approximate mass included in one or more approximate masses or classes selected by the class selector, based on the peak information and the number of charges of the corresponding peak used for calculating that approximate mass by the approximate-mass calculator.

The “m/z spectrum” in the present context is a so-called “mass spectrum”, and more specifically, a spectrum with the horizontal axis representing m/z in place of mass (“profile spectrum”).

### Advantageous Effects of Invention

In the previously described modes of the mass spectrometry data processing method and the mass spectrometer according to the present invention, the mass calculation is performed paying attention to the basic principle that the mass value equals the m/z value corresponding to an ion peak observed in a m/z spectrum multiplied by the correct number of charges of the ion concerned. Therefore, in principle, no artefact can occur, so that the calculation accuracy of the mass value of the target component in the sample can be improved, and a highly reliable analysis result can be obtained. Since the main processing is the repetition of simple calculations and does not require complex computations, only a small amount of memory is consumed during the processing, so that the load on the computer (or the like) can be reduced. The user can easily check the progress of the process for obtaining the result and predict the period of time required for the processing to be completed, which is advantageous for improving the analytical task.

### BRIEF DESCRIPTION OF DRAWINGS

FIG. 1 is a schematic block configuration diagram of a mass spectrometer as one embodiment of the present invention.

FIG. 2 is a flowchart showing the procedure of the data processing by charge deconvolution in the mass spectrometer according to the present embodiment.

FIG. 3 is a diagram showing one example of the m/z spectrum to be analyzed.

FIG. 4 is a diagram illustrating the definition of the left and right ends of a peak detected in a m/z spectrum.

FIG. 5 is a diagram showing an example of the relationship between the mass class and the score obtained in the course of the data processing according to the present embodiment.

FIG. 6 is a diagram schematically illustrating the method for determining the frequency of the approximate mass (histogram) in the data processing according to the present embodiment.

FIG. 7 is a diagram showing a comparison between a mass spectrum determined by using the data processing according to the present embodiment and a mass spectrum determined by using an existing software product.

### DESCRIPTION OF EMBODIMENTS

In the present description, the term “m/z spectrum” refers to a mass spectrum with the horizontal axis representing m/z (profile spectrum), while the term “mass spectrum” refers to a profile spectrum with the horizontal axis representing mass.

In the mass spectrometry data processing method and the mass spectrometer according to the previously described modes of the present invention, the technique of the mass spectrometry is typically a mass spectrometric technique employing an electrospray ionization (ESI) or similar ionization method in which multiply charged ions are easily generated, and more specifically, a method in which multiply charged ions having a considerably wide range of numbers of charges are easily generated.

There is no specific limitation on the technique for separating ions according to their m/z; any appropriate technique can be used, such as a quadrupole mass filter, time-of-flight mass separator or ion cyclotron resonance mass separator. As a matter of course, a mass separator having a high level of mass-resolving power is preferable in order to accurately determine the mass values. From this point of view, time-of-flight mass separators (in particular, multi-turn time-of-flight mass separators or multiple reflection time-of-flight mass separators) or ion cyclotron resonance mass separators are useful.

Hereinafter, one embodiment of the mass spectrometry data processing method according to the present invention and the mass spectrometer employing the same data processing method is described with reference to the attached drawing.

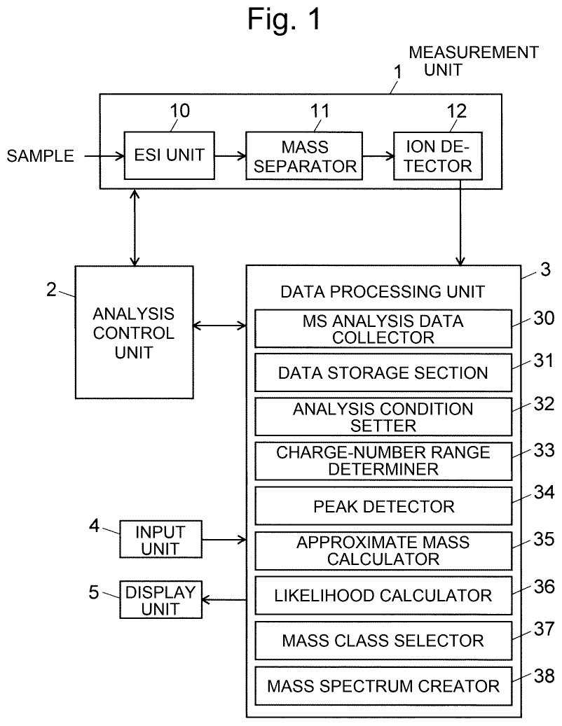

FIG. 1 is a schematic block configuration diagram of the mass spectrometer according to the present embodiment.

In FIG. 1, the measurement unit 1 is a mass spectrometer employing an ESI source, including an ESI section 10, mass separator section 11 and ion detector section 12. The mass separator section 11 should preferably have a high level of mass-resolving power. For example, a time-of-flight mass separator having a reflectron type, multiple reflection type or multi-turn type of configuration may preferably be used. The analysis control unit 2 has the function of controlling the measurement unit 1. The data processing unit 3 has the function of processing detection signals acquired by the measurement unit 1.

The data processing unit 3 includes, as its functional blocks, an MS analysis data collector 30, data storage section 31, data-analysis condition setter 32, charge-number range determiner 33, peak detector 34, approximate-mass calculator 35, likelihood calculator 36, mass class selector 37 and mass spectrum creator 38. An input unit 4 for allowing users to enter predetermined parameters and other pieces of information, as well as a display unit 5 for showing a data-processing result and other pieces of information, are connected to the data processing unit 3.

At least a portion of the analysis control unit 2 and the data processing unit 3 can be constructed by using a personal computer or more sophisticated computer as a hardware resource, with their respective functions realized by running, on the computer, a piece of software (computer program) installed on the same computer.

In the mass spectrometer according to the present embodiment, mass spectrometry data for a sample is acquired as follows.

When a sample containing one or more compounds is introduced into the ESI section 10, the ESI section 10 ionizes the compound molecules contained in the sample. As is commonly known, multiply charged ions having a wide range of numbers of charges are generated in the electrospray ionization. An adduction which results from the addition of an alkali metal or similar substance contained in the sample to the target compound in the same sample may also be generated. The various ions thus generated are introduced into the mass separator section 11 via an ion guide and other elements (not shown), to be separated from each other according to their m/z in the mass separator section 11. For example, if the mass separator section 11 is a time-of-flight mass separator, the various ions almost simultaneously introduced into the mass separator section 11 are spatially separated from each other according to their m/z during their flight through a flight space and sequentially arrive at the ion detector section 12 in ascending order of m/z. The ion detector section 12 produces a detection signal whose intensity corresponds to the number (amount) of ions which have arrived.

In the data processing unit 3, the MS analysis data collector 30 digitizes detection signals received from the measurement unit 1. Then, the MS analysis data collector 30 stores, in the data storage section 31, m/z spectrum data showing the relationship between m/z and intensity. That is to say, this m/z spectrum data is raw profile data. It should be noted that a set of data obtained by performing appropriate noise processing (or the like) on the raw profile data may be stored in the data storage section 31 as the m/z spectrum data.

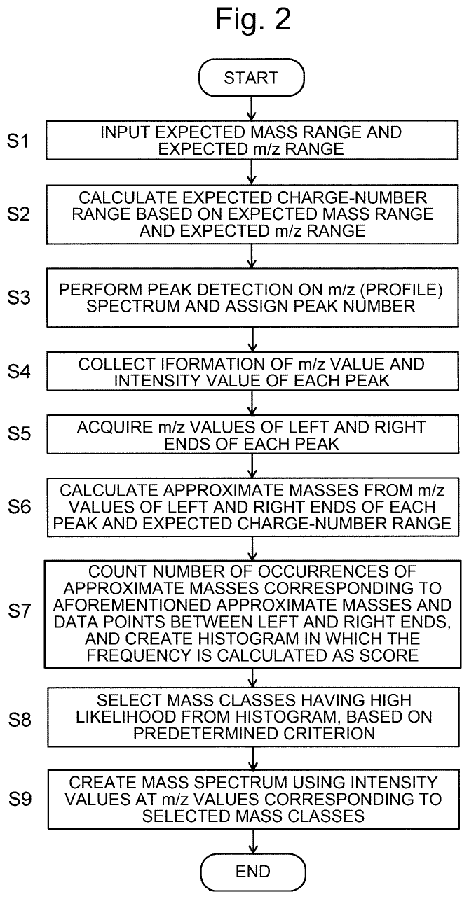

Under the condition that a set of m/z spectrum data obtained as a result of the mass spectrometric analysis on the sample is stored in the data storage section 31, a data processing including the following charge deconvolution is performed. FIG. 2 is a flowchart showing an example of the procedure of this data processing.

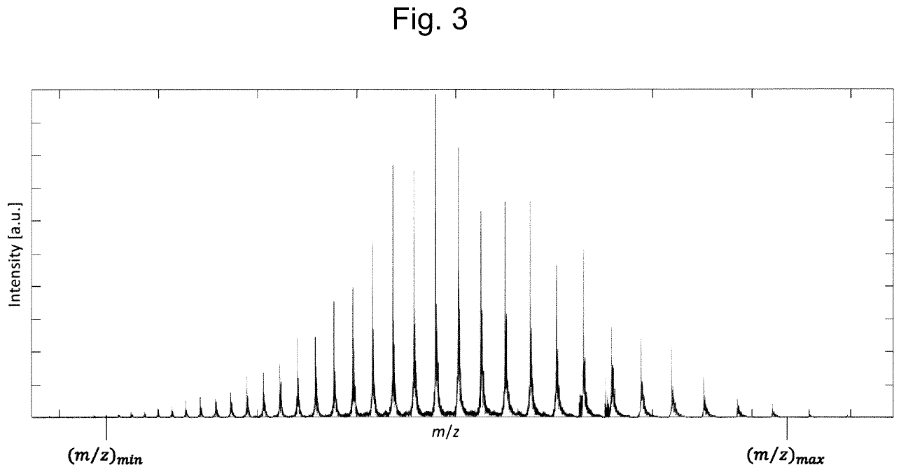

As a specific example, the following description deals with the case where the target compound is a monoclonal antibody (NISTmAb, with an approximate molecular weight of 145,000 Da) deglycosylated by a digestive enzyme, and the data processing is performed on a set of m/z spectrum data acquired by a mass spectrometric analysis performed over the entire length of this compound. FIG. 3 is one example of the m/z spectrum acquired for this compound. This data was acquired by using a quadrupole time-of-flight (Q-TOF) mass spectrometer “LCMS-9050”, manufactured by Shimadzu Corporation. As can be understood from FIG. 3, a considerable number of peaks mainly due to the multiply charged ions are observed since multiply charged ions having a wide range of numbers of charges are generated in the mass spectrometric analysis.

When the data processing is initiated, the data-analysis condition setter 32 receives parameters entered by the user through the input unit 4, i.e., an expected mass range Mₘᵢₙ-Mₘₐₓ predicted for the target compound molecule and an expected m/z range (m/z)ₘᵢₙ-(m/z)ₘₐₓ to be used for the charge deconvolution in the m/z spectrum to be analyzed (Step S1). In normal cases, the expected mass range can be predicted from prior information concerning the target compound. On the other hand, the expected m/z range can be determined, for example, according to a range within which peaks having significant heights can be observed in the m/z spectrum as shown in FIG. 3. It should be noted that a value or values previously determined as default values may be used as one or both of the expected mass range and the expected m/z range in place of the values entered by the user. Step S1 will be bypassed when default values are used for both ranges.

The charge-number range determiner 33 determines an expected charge-number range Zₘᵢₙ-Zₘₐₓ from the expected mass range and the expected m/z range set in Step S1, using the following equation (1) (Step S2). In the case where both the expected mass range and the expected m/z range are default values, the expected charge-number range Zₘᵢₙ-Zₘₐₓ can also be set to its default value.

Zₘᵢₙ=Mₘᵢₙ/{(m/z)ₘₐₓ−mₚ}, Zₘₐₓ=Mₘₐₓ/{(m/z)ₘᵢₙ−mₚ} (1)

It should be noted that mₚ is the mass of proton (1.00728 Da).

The peak detector 34 retrieves, from the data storage section 31, the m/z spectrum data within the expected m/z range set in Step S1 (or determined by default) and performs the peak detection according to a predetermined peak detection algorithm. To each of the detected peaks, the peak detector 34 assigns a number for identifying the peak (Step S3). In the present example, the leftmost peak in the m/z spectrum has a peak number of 1, and this number is sequentially increased by one for each peak in the rightward direction (i.e., in the direction in which m/z value increases).

The m/z spectrum data is a set of data points each of which is the combination of a m/z value and an intensity value. One peak consists of a plurality of data points plotted along the m/z axis. Accordingly, the peak detector 34 collects, for each peak, the m/z values and the intensity values of the data points belonging to the peak and temporarily stores them in the data storage section 31 as peak information (Step S4). The phrase “belonging to the peak” means, for example, that the data points are included within a m/z range from the beginning point to the ending point of the peak or within a m/z range between the left and right ends of the peak (which will be described later).

Additionally, for each detected peak, the peak detector 34 determines the m/z value of the data point corresponding to the left end and that of the data point corresponding to the right end (Step S5). In the present example, the m/z value of the left end and that of the right end of the j-th peak from the left are noted as (m/z)_{j_L} and (m/z)_{j_R}, respectively. The set of m/z spectrum data with the m/z values falling within the section of (m/z)_{j_L}-(m/z)_{j_R} sandwiched between the m/z value of the left end and that of the right end is handled as a set of data belonging to the same peak.

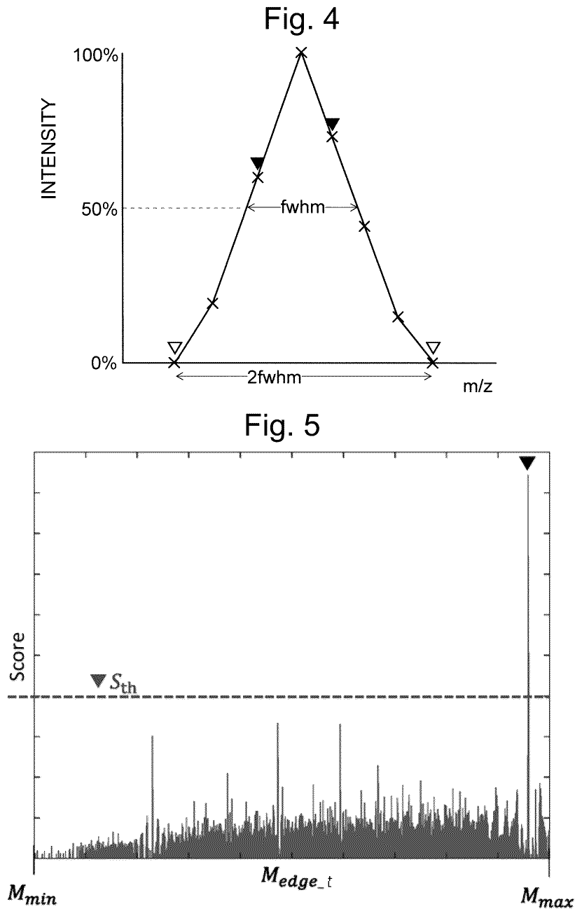

As for the “data point corresponding to the left end” and the “data point corresponding to the right end” in the present context, one of the following definitions can be adopted. FIG. 4 is a diagram illustrating the definitions of the left and right ends of a peak.

As one example, the left and right ends used in the calculation of the full width at half maximum (fwhm) of each peak may be used as the left and right ends. According to this definition, the data points at the positions indicated by the filled triangles in FIG. 4 are selected. As another possibility, a range which is two times the full width at half maximum (2fwhm) and is centered on the center of gravity of the peak may be considered as the peak area, and the left and right ends of this area may be used. According to this definition, the data points indicated by the white triangles in FIG. 4 are selected. Needless to say, other definitions may also be adopted for determining the left and right ends of each peak.

It is also possible to allow the user to determine which of the previously described definitions should be adopted. Alternatively, the peak area may be determined with reference to the value of the mass-resolving power R manually specified by the user through the input unit 4, and the left and right ends may be determined from this peak area. A specific example is as follows: A set of consecutive data points including not only the data points within one peak area as shown in FIG. 4 (indicated by the x-marks) but also all data points whose intensities are equal to or higher than the baseline are extracted, and the m/z value of the peak top or that of the centroid is calculated in the set of data points. Then, by using equation (2) which will be described later, Δ(m/z) is calculated from that m/z value and the mass-resolving power R. The obtained value can be used in place of the full width at half maximum (fwhm) in FIG. 4 for determining the peak area.

Subsequently, for each of all peaks, the approximate-mass calculator 35 calculates approximate masses M_{ij_L} and M_{ij_R} by multiplying each of the m/z values (m/z)_{j_L} and (m/z)_{j_R} of the left and right ends of the peak by each of all numbers of charges Zᵢ within the expected charge-number range Zₘᵢₙ-Zₘₐₓ determined in Step S2 (Step S6). Furthermore, in order to facilitate the task of identifying the number of charges Zᵢ and the peak number j related to an approximate mass calculated for a given peak, an index describing the correspondence relationship of the approximate mass, number of charges and peak number is created and temporarily stored in the data storage section 31.

Next, the likelihood calculator 36 creates a histogram with the horizontal axis representing mass class and the vertical axis representing frequency (occurrence frequency), using the approximate masses M_{ij_L}, M_{ij_R} calculated in Step S6. Specifically, mass classes M_{edge_1}, M_{edge_2}, . . . each having a predetermined mass width ΔM_{edge} are set on the horizontal axis of the histogram, and for each of the approximate masses M_{ij_L} and M_{ij_R} of each peak, a mass class M_{edge} which includes that approximate mass is located, and the frequency count of that mass class M_{edge} is increased by one. Additionally, the m/z values of all data points which are sandwiched between the m/z values (m/z)_{j_L} and (m/z)_{j_R} of the left and right ends, i.e., which belong to the same peak, are similarly reflected into the histogram after the corresponding approximate masses are calculated by multiplying each m/z value by each of all numbers of charges Zᵢ within the expected charge-number range Zₘᵢₙ-Zₘₐₓ (Step S7).

The mass classes M_{edge_t} (where t=1, 2, . . . ) on the horizontal axis can be set with a previously and internally determined pitch of mass width ΔM_{edge} within the expected mass range set in Step S1. For example, the mass width ΔM_{edge} may be a value on the order of 10 ppm to 100 ppm of the lower limit Mₘᵢₙ or upper limit Mₘₐₓ of the expected mass range set in Step S1. This mass width ΔM_{edge} should preferably be determined depending on the mass-resolving power used at the time of the measurement, or depending on the mass-resolving power (or its range) specified in the measurement apparatus, so that it will be an appropriate mass width larger than the mass-resolving power. The reason is because setting an extremely narrow mass width ΔM_{edge} as compared to the mass-resolving power will cause a situation in which the mass classes to which the approximate masses belong are so discretely distributed that a mass class having a large frequency is unlikely to occur.

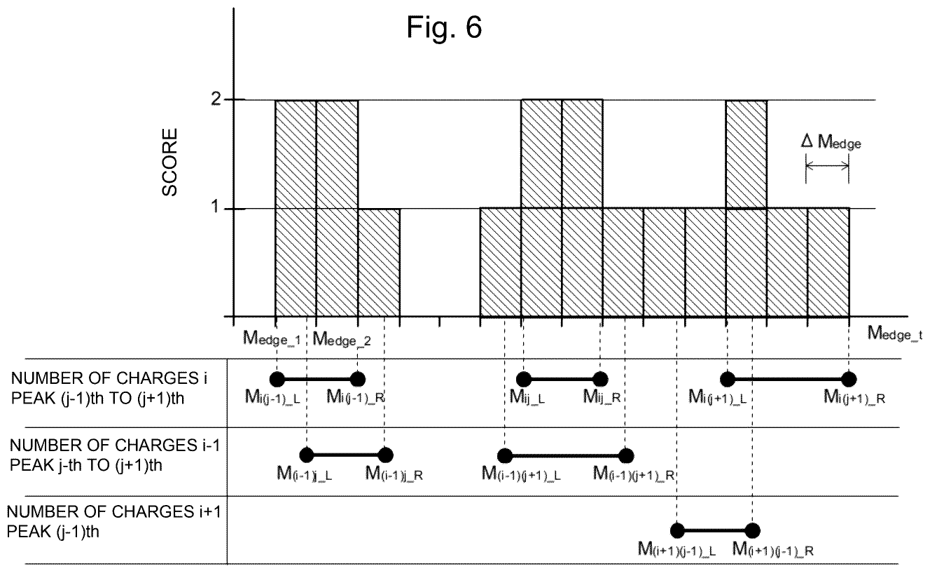

FIG. 6 is an extremely schematic diagram illustrating the method for creating a histogram in Step S7. Consider the case where there are three values i−1, i and i+1 as the numbers of charges Zᵢ within the expected charge-number range Zₘᵢₙ-Zₘₐₓ, and three peaks having peak numbers j−1, j and j+1. With these combinations, suppose that six pairs of approximate masses M_{ij_L} and M_{ij_R} as shown in FIG. 6 have been obtained. The frequency count of each mass class which corresponds to one of the approximate masses M_{ij_L} and M_{ij_R} (a mass class which the broken line that vertically extends upward from a filled circle meets in FIG. 6) is increased by one. Accordingly, for example, mass class M_{edge_1} in which there are two approximate masses M_{i(j-1)_L} and M_{(i-1)j_L} has a frequency of 2. On the other hand, mass class M_{edge_3} in which there is only one approximate mass M_{(i-1)j_R} has a frequency of 1. Furthermore, mass classes located between two mass classes which correspond to one combination of the approximate masses M_{ij_L} and M_{ij_R} should be considered to correspond to data points belonging to the same peak, and therefore, its frequency count should also be similarly increased. Accordingly, for example, the frequency count of mass class M_{edge_2} located between the approximate masses M_{(i-1)j_L} and M_{(i-1)j_R} is increased to 2. Consequently, a histogram showing the occurrence frequency of the approximate masses corresponding to each peak is obtained.

The frequency which is the vertical axis of the histogram thus created can be considered to represent the likelihood of the corresponding mass class, i.e., the likelihood of the approximate mass of the compound molecule in the sample estimated from the m/z spectrum. Accordingly, this frequency, or the likelihood, is treated as the “score” in the present data processing method. The score takes an integer value equal to or greater than zero. After the completion of the histogram, an index showing the correspondence relationship between the mass class and the approximate mass may preferably be created and temporarily stored in the data storage section 31 so that the approximate masses Mₖ (M_{ij_L}≤Mₖ≤M_{ij_R}) belonging to each mass class M_{edge_t} can be easily identified.

The mass class selector 37 selects one or more mass classes M_{edge_u} having high scores in the histogram (Step S8). As an example of the method for selecting mass classes, the user may specify a threshold beforehand in Step S1, and all mass classes which have higher scores than the threshold may be selected. Alternatively, a predetermined number of mass classes may be automatically selected in descending order of the score, regardless of the values of the scores.

FIG. 5 is an example of the histogram created based on an actually measured m/z spectrum. In this example, the threshold of the score is set at Sₜₕ. The mass class projecting like a peak indicated by the filled triangle will be selected.

Next, the mass spectrum creator 38 creates a mass spectrum having a horizontal axis M_{cand_m} and a vertical axis I_{cand_m} newly defined based on the information corresponding to the approximate masses Mₖ belonging to the one or more mass classes M_{edge_u} selected in Step S8 and calculates a more accurate mass (estimated mass) of the compound corresponding to those approximate masses Mₖ (Step S9).

Specifically, the plurality of approximate masses Mₖ belonging to each selected mass class M_{edge_u} can be easily determined by referring to the index showing the correspondence relationship between the mass class and the approximate mass created in Step S7. Furthermore, the number of charges and the peak number corresponding to each of the determined approximate masses Mₖ can be easily identified by referring to the index describing the correspondence relationship of the approximate mass, number of charges and peak number created in Step S6. Once the peak number has been identified, the m/z value and the intensity value of that peak, obtained in Step S4, can be conveniently determined. It should be noted that, even without referring to these indices, the m/z value and the intensity value of each data point belonging to the peak corresponding to the mass classes M_{edge_u} selected in Step S8 can be determined by sequentially following the computed results.

The positions M_{cand_1}, M_{cand_2}, . . . of the points on the horizontal axis (mass axis) of the mass spectrum can be set, for example, at intervals of the pitch width w determined from the mass-resolving power R of the used mass spectrometer and the number of data points np constituting one peak, within a range centered on the selected mass class M_{edge_u} with a predetermined margin provided before and after the same mass class. That is to say, since the mass-resolving power R is given by:

R=(m/z)/Δ(m/z)=M/ΔM (2)

the pitch width w can be calculated by:

w=ΔM/nₚ=M/(nₚR).

In the peak detection process in Step S3, the mass-resolving power R can be calculated from a representative peak among the detected peaks, and the number of data points forming this peak can also be determined and set as the number of data points nₚ. Alternatively, the mass-resolving power and the number of data points of a peak may be entered and set by the user in Step 1 as parameters for the data processing, and those parameters may be used for the processing in Step S9.

After the pitch on the horizontal axis of the mass spectrum has been determined in the previously described manner, the mass spectrum creator 38 treats all approximate masses Mₖ satisfying M_{cand_m}≤Mₖ<M_{cand_(m+1)} as M_{cand_m}. Accordingly, the value on the vertical axis corresponding to a given mass M_{cand_m}, i.e., the intensity I_{cand_m}, is the sum ΣₖIₖ of the intensities of all approximate masses Mₖ satisfying M_{cand_m}≤Mₖ<M_{cand_(m+1)}. This is the sum of the intensity values of all data points belonging to the peak corresponding to each mass class selected in Step S8. In other words, this processing is equivalent to the execution of a binning process in which the intensity values of a plurality of data points corresponding to the mass class are combined for each mass class selected in Step S8. Thus, the mass spectrum can be created by determining an intensity value for each mass according to the mass pitch width w, i.e., at each position M_{cand_1}, M_{cand_2}, . . . .

After the mass spectrum has been obtained, the mass spectrum creator 38 acquires the value of the mass corresponding to the position of the peak top of the peak in the mass spectrum as the estimated mass of the target compound. Furthermore, the mass spectrum creator 38 displays the created mass spectrum on the screen of the display unit 5 according to an instruction by the user through the input unit 4.

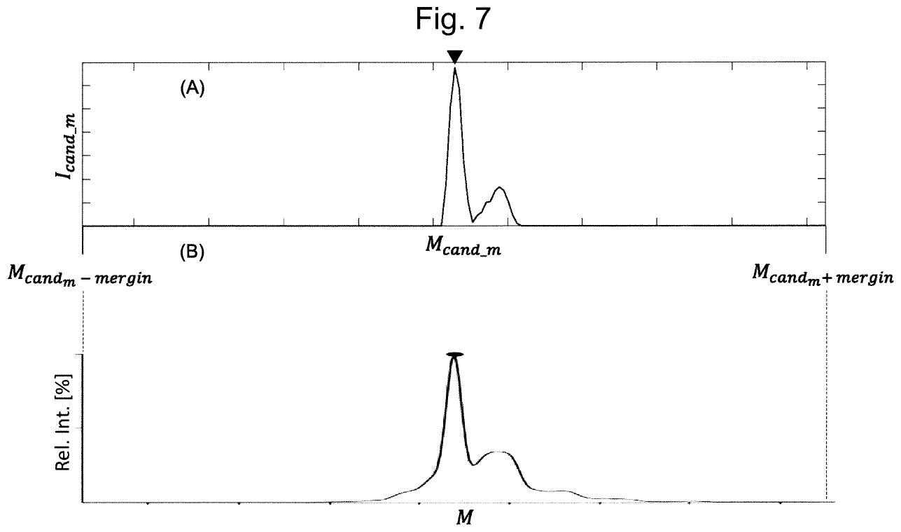

Diagram (A) in FIG. 7 is a mass spectrum in which the approximate masses Mₖ belonging to each mass class M_{edge_u} and the intensities Iₖ of the corresponding data points are plotted as M_{cand_m} and I_{cand_m} according to the mass pitch width w which has been set reflecting the mass-resolving power of the mass spectrometer used for the measurement. By comparison, diagram (B) in FIG. 7 shows a mass spectrum showing the result obtained by performing a charge deconvolution by using “UniDec”, an existing software product (see Non Patent Literature 4), on the same set of m/z spectrum data as used in the case of diagram (A) in FIG. 7, under the same setting of the expected mass range and the expected m/z range.

As can be understood from the comparison of diagrams (A) and (B) in FIG. 7, the mass spectrum created by the previously described data processing method is drawn with a higher resolution, i.e., a higher level of accuracy, as compared to the mass spectrum created by “UniDec”. This demonstrates that, by using the present data processing method, a mass spectrum with a high level of mass resolution can be created, and the mass of the target compound can also be estimated with a high level of accuracy.

In the case where a plurality of compounds are contained in the sample, a plurality of groups of mass classes located apart from each other corresponding to those compounds may possibly be selected. In that case, a mass spectrum can be created for each group of mass classes.

As described thus far, the mass spectrometer according to the present embodiment can acquire a highly accurate mass spectrum by performing characteristic data processing on a m/z spectrum in which peaks originating from multiply charged ions having a wide range of numbers of charges, peaks originating from adduct ions, as well as isotopic envelopes (or the like) are observed. Furthermore, a highly accurate mass value of the target compound can be obtained from this mass spectrum.

The mass spectrometry data processing method and the mass spectrometer according to the previous embodiment allow for various changes or modifications other than those already described. For example, in the previous description of the data-processing procedure, various indices are created in the course of the processing. As noted earlier, this is merely aimed at reducing the processing time by referring to those indices. It is evident that a similar processing can also be performed without creating those indices.

The sequence of data processing from Steps S1 through S9 does not need to be continuously performed; it is also possible to allow for an intervention by the user in the middle of the processing. For example, a histogram as shown in FIG. 5, created in Step S7, may be temporarily shown on the screen of the display unit 5 in order to allow the user to visually check the histogram and set the threshold of the score. A m/z spectrum as shown in FIG. 3 may also be temporarily shown on the screen of the display unit 5 before the peak detection in order to allow the user to visually check the spectrum before issuing an instruction to continue the data analysis.

This enables an early detection of a situation in which, for example, the scores are generally at considerably low levels and inappropriate for performing the selection of mass classes, thereby allowing the user to correct the related parameters or find problems with the measurement itself.

In the previous embodiment, as shown in FIG. 6, the number of approximate masses included in each mass class is counted to determine the frequency corresponding to each mass class as the score. In the case where the approximate masses have discrete values with comparatively large steps, the occurrence frequency of each value of the approximate mass, rather than each mass class, may be determined as the score.

It should be noted that the previously described embodiment and various modified examples are also mere examples of the present invention and will be naturally included within the scope of claims of the present application even when an appropriate change, modification or addition (or the like) is made within the spirit of the present invention.

### Various Modes

It is evident to a person skilled in the art that the previously described illustrative embodiment is a specific example of the following modes of the present invention.

(Clause 1) One mode of the mass spectrometry data processing method according to the present invention is a data processing method for processing data acquired by performing a mass spectrometric analysis on a sample, the method including:
a peak-information acquisition step for performing peak detection on a m/z spectrum based on the acquired data, and for collecting peak information including the m/z values of a plurality of detected peaks;
an approximate-mass calculation step for calculating approximate masses by multiplying the m/z value of each peak included in the peak information, by each of a plurality of numbers of charges within an expected charge-number range determined beforehand;
a class selection step for determining, for a plurality of approximate masses calculated in the approximate-mass calculation step, the frequency of each approximate mass or each class having a predetermined mass width as a likelihood of the approximate mass, and for selecting an approximate mass or a class estimated to be highly reliable based on the likelihood; and
an estimated-mass calculation step for calculating an estimated mass of a compound corresponding to an approximate mass included in one or more approximate masses or classes selected in the class selection step, based on the peak information and the number of charges of the corresponding peak used for calculating that approximate mass in the approximate-mass calculation step.

(Clause 6) One mode of the mass spectrometer according to the present invention includes:
a measurement section configured to perform a mass spectrometric analysis on a sample to acquire data;
a peak-information acquirer configured to perform peak detection on a m/z spectrum based on the data acquired by the measurement section, and to collect peak information including the m/z values of a plurality of detected peaks;
an approximate-mass calculator configured to calculate approximate masses by multiplying the m/z value of each peak included in the peak information, by each of a plurality of numbers of charges within an expected charge-number range determined beforehand;
a class selector configured to determine, for a plurality of approximate masses calculated by the approximate-mass calculator, the frequency of each approximate mass or each class having a predetermined mass width as a likelihood of the approximate mass and to select an approximate mass or a class estimated to be highly reliable based on the likelihood; and
an estimated-mass calculator configured to calculate an estimated mass of a compound corresponding to an approximate mass included in one or more approximate masses or classes selected by the class selector, based on the peak information and the number of charges of the corresponding peak used for calculating that approximate mass by the approximate-mass calculator.

In the mass spectrometry data processing method according to Clause 1 and the mass spectrometer according to Clause 6, the mass calculation is performed paying attention to the basic principle that the mass value equals the m/z value corresponding to an ion peak observed in a m/z spectrum multiplied by the correct number of charges of the ion concerned. Therefore, in principle, no artefact can occur. Consequently, the calculation accuracy of the mass value of the target component in the sample can be improved, and a highly reliable analysis result can be obtained. Since the main processing is the repetition of simple calculations and does not require complex computations, only a small amount of memory is consumed during the processing, so that the load on the computer (or the like) can be reduced. The user can easily check the progress of the process for obtaining the result and predict the period of time required for the processing to be completed, which is advantageous for improving the analytical task.

(Clause 2) In the mass spectrometry data processing method according to Clause 1, the peak information may include an intensity value of each peak in addition to the m/z value of the peak, and the approximate mass selection step may include a spectrum creation step for creating a mass spectrum in which the horizontal axis represents a mass and the vertical axis represents the intensity value based on the peak information and the number of charges of each peak corresponding to each approximate mass.

(Clause 7) In the mass spectrometer according to Clause 6, the peak information may include an intensity value of each peak in addition to the m/z value of the peak, and the estimated-mass calculator may include a spectrum creator configured to create a mass spectrum in which the horizontal axis represents a mass and the vertical axis represents the intensity value based on the peak information and the number of charges of each peak corresponding to each approximate mass.

In the mass spectrometry data processing method according to Clause 2 and the mass spectrometer according to Clause 7, the horizontal axis of the mass spectrum may preferably have a mass pitch width determined according to the mass-resolving power of the mass spectrometer used for the measurement.

By the mass spectrometry data processing method according to Clause 2 and the mass spectrometer according to Clause 7, a highly accurate mass spectrum can be created, and the mass of the target compound in the sample can be determined according to the position of the peak (or the like) in that mass spectrum. Consequently, the mass of the target compound can be provided to the user, and furthermore, information reflecting the isotopic distribution can be provided.

(Clause 3) In the mass spectrometry data processing method according to Clause 2, the spectrum creation step may include creating the mass spectrum by performing a binning process on the data with a mass width determined according to the mass resolution of a peak in the m/z spectrum.

(Clause 8) In the mass spectrometer according to the 7, the spectrum creator may be configured to create the mass spectrum by performing a binning process on the data with a mass width determined according to the mass resolution of a peak in the m/z spectrum.

By the mass spectrometry data processing method according to Clause 3 and the mass spectrometer according to Clause 8, a highly accurate mass spectrum can be created by effectively using the ion intensity information obtained in the measurement.

(Clause 4) The mass spectrometry data processing method according to one of Clauses 1-3 may further include:
a condition setting step for setting, in response to an input operation by a user, at least one of a mass range and a m/z range expected for a compound to be analyzed; and
a charge-number range calculation step for calculating the expected charge-number range using one or both of the mass range and the m/z range set in the condition setting step.

(Clause 9) The mass spectrometer according to one of Clauses 6-8 may further include:
a condition setter configured to set, in response to an input operation by a user, at least one of a mass range and a m/z range expected for a compound to be analyzed; and
a charge-number range calculator configured to calculate the expected charge-number range using one or both of the mass range and the m/z range set by the condition setter.

The wider the expected charge-number range is, the higher the reliability of the likelihood of the approximate mass can be. However, it also means a corresponding increase in the amount of calculation, which in turn increases the amount of load on the computer and also elongates the processing time. To address this problem, the mass spectrometry data processing method according to Clause 4 and the mass spectrometer according to Clause 9allows the user to limit the mass range or m/z range based on prior information available for the user. This allows for the reduction of calculations that do not significantly contribute to an improvement in the reliability of the analysis result, whereby the load on the computer can be reduced and the processing time can also be shortened.

(Clause 5) In the mass spectrometry data processing method according to one of Clauses 1-4, the class selection step may include comparing the likelihood with a predetermined threshold and estimate that the approximate mass or the class corresponding to the likelihood is highly reliable if the likelihood exceeds the threshold.

(Clause 10) In the mass spectrometer according to one of Clauses 6-9, the class selector may be configured to compare the likelihood with a predetermined threshold and estimate that the approximate mass or the class corresponding to the likelihood is highly reliable if the likelihood exceeds the threshold.

In the mass spectrometry data processing method according to Clause 5 and the mass spectrometer according to Clause 10, the threshold of the likelihood may be previously determined, or the user may be allowed to set the threshold. By the mass spectrometry data processing method according to Clause 5 and the mass spectrometer according to Clause 10,an appropriate mass class can be selected, based on which a highly accurate mass spectrum can be created, or the mass of the target compound can be calculated with a high level of accuracy.

### REFERENCE SIGNS LIST

1 . . . Measurement Unit
10 . . . ESI Section
11 . . . Mass Separator Section
12 . . . Ion Detector Section
2 . . . Analysis Control Unit
3 . . . Data Processing Unit
30 . . . MS Analysis Data Collector
31 . . . Data Storage Section
32 . . . Data-Analysis Condition Setter
33 . . . Charge-Number Range Determiner
34 . . . Peak Detector
35 . . . Approximate-Mass Calculator
36 . . . Likelihood Calculator
37 . . . Mass Class Selector
38 . . . Mass Spectrum Creator
4 . . . Input Unit
5 . . . Display Unit

1. A mass spectrometry data processing method for processing data acquired by performing a mass spectrometric analysis on a sample, comprising:
a peak-information acquisition step for performing peak detection on a m/z spectrum based on the acquired data, and for collecting peak information including m/z values of a plurality of detected peaks;
an approximate-mass calculation step for calculating approximate masses by multiplying the m/z value of each peak included in the peak information, by each of a plurality of numbers of charges within an expected charge-number range determined beforehand;
a class selection step for determining, for a plurality of approximate masses calculated in the approximate-mass calculation step, a frequency of each approximate mass or each class having a predetermined mass width as a likelihood of the approximate mass, and for selecting an approximate mass or a class estimated to be highly reliable based on the likelihood; and
an estimated-mass calculation step for calculating an estimated mass of a compound corresponding to an approximate mass included in one or more approximate masses or classes selected in the class selection step, based on the peak information and a number of charges of the corresponding peak used for calculating that approximate mass in the approximate-mass calculation step.

2. The mass spectrometry data processing method according to claim 1, wherein:
the peak information includes an intensity value of each peak in addition to the m/z value of the peak; and
the approximate mass selection step includes a spectrum creation step for creating a mass spectrum in which a horizontal axis represents a mass and a vertical axis represents the intensity value based on the peak information and the number of charges of each peak corresponding to each approximate mass.

3. The mass spectrometry data processing method according to claim 2, wherein the spectrum creation step includes creating the mass spectrum by performing a binning process on the data with a mass width determined according to a mass resolution of a peak in the m/z spectrum.

4. The mass spectrometry data processing method according to claim 1, further comprising:
a condition setting step for setting, in response to an input operation by a user, at least one of a mass range and a m/z range expected for a compound to be analyzed; and
a charge-number range calculation step for calculating the expected charge-number range using one or both of the mass range and the m/z range set in the condition setting step.

5. The mass spectrometry data processing method according to claim 1, wherein the class selection step includes comparing the likelihood with a predetermined threshold and estimate that the approximate mass or the class corresponding to the likelihood is highly reliable if the likelihood exceeds the threshold.

6. A mass spectrometer, comprising:
a measurement section configured to perform a mass spectrometric analysis on a sample to acquire data;
a peak-information acquirer configured to perform peak detection on a m/z spectrum based on the data acquired by the measurement section, and to collect peak information including m/z values of a plurality of detected peaks;
an approximate-mass calculator configured to calculate approximate masses by multiplying the m/z value of each peak included in the peak information, by each of a plurality of numbers of charges within an expected charge-number range determined beforehand;
a class selector configured to determine, for a plurality of approximate masses calculated by the approximate-mass calculator, a frequency of each approximate mass or each class having a predetermined mass width as a likelihood of the approximate mass and to select an approximate mass or a class estimated to be highly reliable based on the likelihood; and
an estimated-mass calculator configured to calculate an estimated mass of a compound corresponding to an approximate mass included in one or more approximate masses or classes selected by the class selector, based on the peak information and the number of charges of the corresponding peak used for calculating that approximate mass by the approximate-mass calculator.

7. The mass spectrometer according to claim 6, wherein:
the peak information includes an intensity value of each peak in addition to the m/z value of the peak; and
the estimated-mass calculator includes a spectrum creator configured to create a mass spectrum in which a horizontal axis represents a mass and a vertical axis represents the intensity value based on the peak information and the number of charges of each peak corresponding to each approximate mass.

8. The mass spectrometer according to claim 7, wherein the spectrum creator is configured to create the mass spectrum by performing a binning process on the data with a mass width determined according to a mass resolution of a peak in the m/z spectrum.

9. The mass spectrometer according to claim 6, further comprising:
a condition setter configured to set, in response to an input operation by a user, at least one of a mass range and a m/z range expected for a compound to be analyzed; and
a charge-number range calculator configured to calculate the expected charge-number range using one or both of the mass range and the m/z range set by the condition setter.

10. The mass spectrometer according to claim 6, wherein the class selector is configured to compare the likelihood with a predetermined threshold and estimate that the approximate mass or the class corresponding to the likelihood is highly reliable if the likelihood exceeds the threshold.
